(19) United States
(12) Patent Application Publication
(10) Pub. No.: US 2009/0228640 A1
(43) Pub. Date: Sep. 10, 2009

(54) INFORMATION PROCESSING APPARATUS AND NON-VOLATILE SEMICONDUCTOR MEMORY DRIVE

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/391,126

(22) Filed: Feb. 23, 2009

Related U.S. Application Data
(63) Continuation of application No. PCT/JP2008/071175, filed on Nov. 14, 2008.

(30) Foreign Application Priority Data
Mar. 7, 2008 (JP) 2008-058542

(51) Int. Cl. G06F 12/02; G06F 12/00

(52) U.S. Cl. 711/103; 711/E12.001; 711/E12.008

(57) ABSTRACT

According to one embodiment, an information processing apparatus of the invention includes an information processing apparatus main body, and a non-volatile semiconductor memory drive which is accommodated in the information processing apparatus main body. The information processing apparatus main body includes a clock module which counts time information, and a main control module which outputs the time information to be counted by the clock module to the non-volatile semiconductor memory drive upon powering on. The non-volatile semiconductor memory drive includes a counter, and a memory control module which calculates and manages times upon powering on and shutting down power and an elapsed time from the time upon last shutting down power to time upon present powering on based on a value of the counter and the time information input from the information processing apparatus main body.

### CROSS-REFERENCE TO RELATED APPLICATIONS

This is a Continuation Application of PCT Application No. PCT/JP2008/071175, filed Nov. 14, 2008, which was published under PCT Article 21(2) in English.

This application is based upon and claims the benefit of priority from Japanese Patent Application No. 2008-058542, filed Mar. 7, 2008, the entire contents of which are incorporated herein by reference.

### BACKGROUND

1. Field

One embodiment of the invention relates to an information processing apparatus and a non-volatile semiconductor memory drive.

2. Description of the Related Art

As regards a conventional technique, a non-volatile semiconductor memory drive using a non-volatile semiconductor memory as an external storage device has been proposed. The non-volatile semiconductor memory to be used for such a non-volatile semiconductor memory drive controls data writing and data reading on the basis of hold and discharge of negative electric charges at a floating gate of a memory cell transistor.

In such a non-volatile semiconductor memory drive, as the memory cell transistor becomes minute and highly integrated, it has become very hard to hold data. Since the negative electric charges injected to the floating gate is gradually discharged over time, a problem such that a threshold voltage of the memory cell transistor is decreased and, for example, the data changes from “0” to “1” is posed.

To solve such a problem, a non-volatile semiconductor device, which performs a retention check to check a storage state of the data stored in the non-volatile semiconductor memory in supplying power, has been proposed (e.g., Jpn. Pat. Appln. KOKAI Publication No. 2006-338789).

However, according to this proposal, even if it is assumed that a time period, in which power is turned on again from shut down of power, is a very short time period which does not need a retention check, a retention check is subject to be performed in turning on the power regardless of the length of the time period.

Meanwhile, since the non-volatile semiconductor memory drive does not include a module such as a real time clock for clocking the time period, it is impossible to appropriately determine the timing to perform the retention check. Mounting the module such as a real time clock causes an increase in cost and in consumed power.

The invention has been made in consideration of the above, and an object of the invention is to provide an information processing apparatus and a non-volatile semiconductor memory drive for realizing appropriate execution of the retention check.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the invention;

FIG. 2 is an exemplary block diagram showing a schematic configuration of the information processing apparatus according to the embodiment;

FIG. 3 is an exemplary block diagram showing a schematic configuration of a solid-sate drive (SSD) according to the embodiment;

FIG. 4 is an exemplary schematic view showing storage capacities and storage areas of the SSD according to the embodiment;

FIG. 5 is an exemplary schematic view of a NAND memory according to the embodiment;

FIG. 6 is an exemplary view showing an operating time of the SSD of the embodiment;

FIG. 7 is an exemplary flowchart showing operations of the information processing apparatus of the embodiment;

FIG. 8 is an exemplary flowchart showing operations of the SSD of the embodiment; and

FIG. 9 is an exemplary view showing an image display in which dates and times are given to event logs.

### DETAILED DESCRIPTION

Various embodiments according to the invention will be described hereinafter with reference to the accompanying drawings. In general, according to one embodiment of the invention, an information processing apparatus of the invention includes an information processing apparatus main body, and a non-volatile semiconductor memory drive which is accommodated in the information processing apparatus main body. The information processing apparatus main body includes a clock module which counts time information, and a main control module which outputs the time information to be counted by the clock module to the non-volatile semiconductor memory drive upon powering on. The non-volatile semiconductor memory drive includes a counter, and a memory control module which calculates and manages times upon powering on and shutting down power and an elapsed time from the time upon last shutting down power to time upon present powering on based on a value of the counter and the time information input from the information processing apparatus main body.

(Configuration of Information Processing Apparatus)

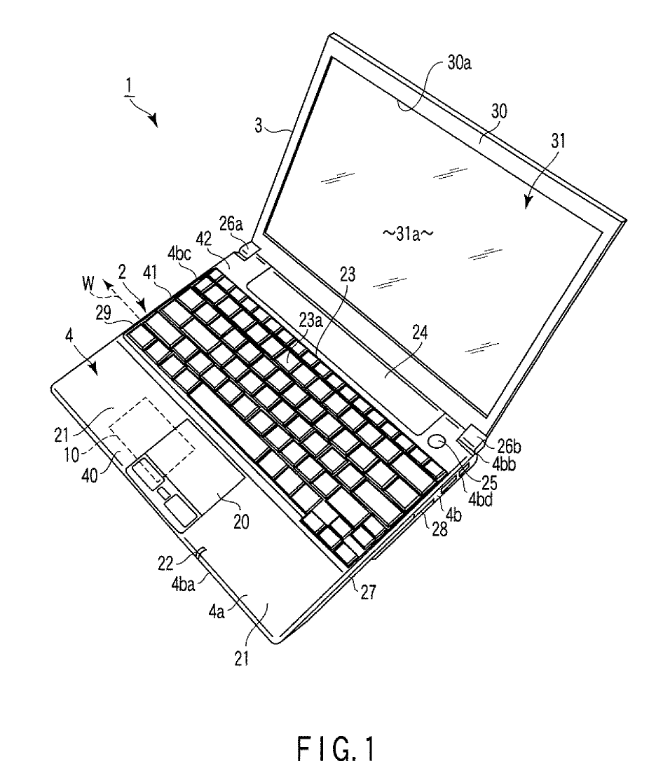

FIG. 1 is an exemplary perspective view showing an external appearance of an information processing apparatus 1 according to an embodiment of the invention. The information processing apparatus 1 is composed of a main body 2, and a display unit 3 attached to the main body 2, as shown in FIG. 1.

The main body 2 has a box-shaped housing 4, and the housing 4 includes a top wall 4a, a peripheral wall 4b and a bottom wall (not shown). The top wall 4a of the housing 4 includes a front part 40, a central part 41 and a back part 42 which are arranged in order from a side close to a user who operates the information processing apparatus 1. The bottom wall is positioned opposite side of the top wall 4a, and faces an installation surface on which the information processing apparatus 1 is placed. The peripheral wall 4b includes a front wall 4ba, a rear wall 4bb, and right and left sidewalls 4bc, 4bd.

The front part 40 includes a touch pad 20 which is a pointing device, a palm rest 21, and a liquid crystal display (LED) 22 which illuminates in conjunction with an operation of each of the components of the information processing apparatus 1.

The central part 41 includes a keyboard mounting part 23 on which a keyboard 23a capable of inputting character information, etc., is mounted.

The back part 42 includes a battery pack 24 which is detachably attached, a power switch 25 for turning on the power of the information processing apparatus 1 on the right side of the battery pack 24, and a pair of hinge portions 26a, 26b which rotatably supports the display unit 3 at the right and left sides of the battery pack 24.

An exhaust port 29 (not shown) for exhausting wind “W” from inside of the housing 4 to the outside thereof is disposed on the left sidewall 4bc of the housing 4. An optical disc drive (ODD) 27 capable of reading/writing data from/to an optical storage medium such as a DVD, and a card slot 28 in/from which various cards can be inserted/removed are disposed on the right sidewall 4bd.

The housing 4 is formed of a housing cover including a part of the peripheral wall 4b and the top wall 4a, and a housing base including a part of the peripheral wall 4b and the bottom wall. The housing cover is detachably coupled to the housing base to form a housing space along with the housing base. The housing space houses a solid-state drive (SSD) 10, etc., as a non-volatile semiconductor memory drive. Details of the SSD 10 will be described later.

The display unit 3 includes a display housing 30 including an opening 30a and a display device 31 composed of an LCD, etc., capable of displaying images on a display 31a. The display device 31 is housed in the display housing 30, and the display 31a is exposed to the outside of the display housing 30 through the opening 30a.

In the housing 4, a main circuit board, an expansion module, a fan, etc., not shown, are housed, as welt as the SSD 10, the battery pack 24, the ODD 27 and the card slot 28.

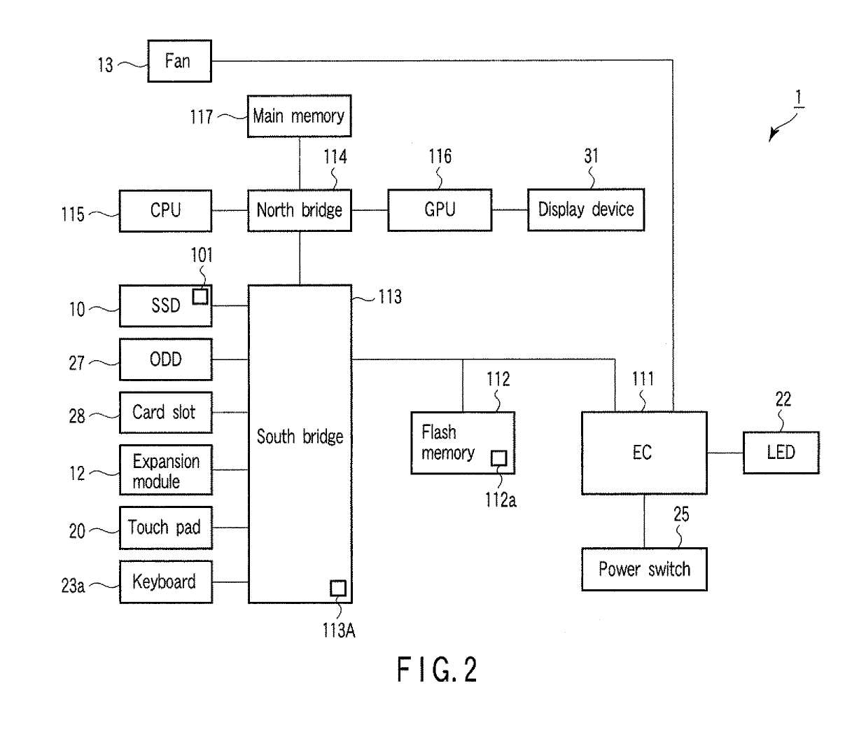

FIG. 2 is an exemplary block diagram showing a schematic configuration of the information processing apparatus 1 according to the embodiment of the invention.

The information processing apparatus 1 includes, as shown in FIG. 2, an embedded controller (EC) 111 which is an embedded system for controlling each component, a flash memory 112 which stores a basic input/output system (BIOS) 112a, a south bridge 113 which is a large scale integration (LSI) chip and functions as various bus controllers and as an I/O controller, a north bridge 114, which is an LSI chip, for controlling connections among a central processing unit (CPU) 115 to be described later, a graphic processing unit (GPU) 116, a main memory 117 and various buses, a CPU 115 as a main control unit for computing various signals, a GPU 116 which controls and computes video signals for display, and a main memory 117 read and written by the CPU 115, as well as the SSD 10, the expansion module 12, the fan 13, the touch pad 20, the LED 22, the keyboard 23a, the power switch 25, the ODD 27, the card slot 28 and the display device 31.

The expansion module 12 includes an expansion circuit board, a card socket mounted on the expansion circuit board, and an expansion module board inserted in the card socket. The card socket is based on the standards of Mini-PCI, etc., and the expansion module board may be a third generation (3G) module, a television tuner, a GSP module and a Wimax (trademark) module.

The fan 13 is a cooling unit which cools the inside of the housing 4 by means of ventilation, and exhausts the air in the housing 4 to the outside as wind “W” via the exhaust port 29 (not shown).

The EC 111, the flush memory 112, the south bridge 113, the north bridge 114, the CPU 115, the GPU 116 and the main memory 117 are the electronic components mounted on the main circuit board.

The south bridge 113 has a real time clock (hereinafter referred to as RTC) 113A which clocks a real time, and of which the power supply is backed up by a battery such as a button battery. The RTC 113A operates on the basis of the power to be supplied from the battery even in a state in which the power of the information processing apparatus 1 has been turned off. The RTC 113A has a memory for storing calendar information as well as time information.

(Configuration of SSD)

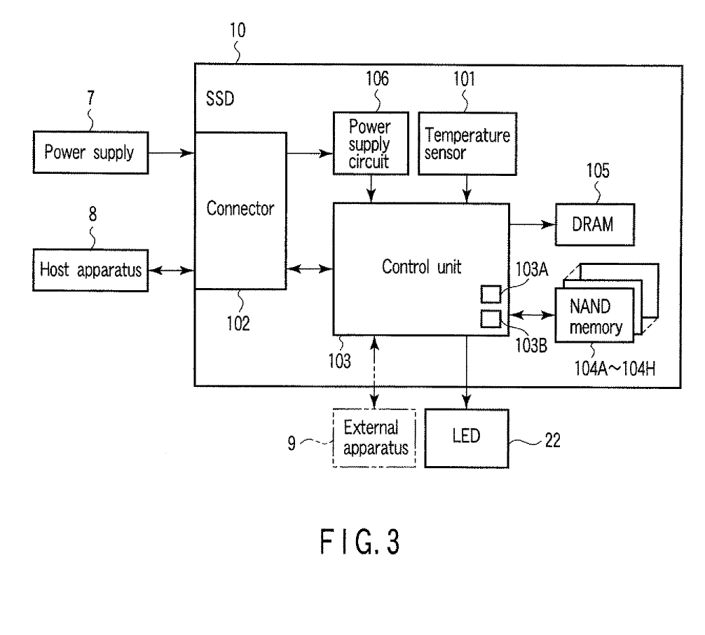

FIG. 3 is an exemplary block diagram showing a schematic configuration of the SSD 10 according to the embodiment of the invention. The SSD 10 is schematically formed of a temperature sensor 101, a connector 102, a control unit 103, NAND memories 104A-104H, a DRAM 105, and a power supply circuit 106, as shown in FIG. 3. The SSD 10 is an external storage device which stores data and programs and from which records are not lost even if the power is not supplied thereto. Although the SSD 10 has no drive mechanism such as a magnetic disk or a head like a conventional hard disk drive, the SSD 10 stores program such as an operating system (OS), data generated by a user or executing software, etc., readably and secularly in the storage areas of the NAND memories in the same way as that of the hard disk drive, and is a drive composed of a non-volatile semiconductor memory capable of operating as a boot drive of the information processing apparatus 1.

The control unit 103 as a memory controller is connected to each of the connector 102, the eight NAND memories 104A-104H, the DRAM 105 and the power supply circuit 106.

The control unit 103 is connected to a host apparatus 8 via the connector 102, and is connected to the external apparatus 9, as necessary. Further, the control unit 103 is provided with a counter 103A which counts a career time after the SSD 10 has been activated at the beginning and with a real time acquisition module 103B acquiring time information input from the outside.

A power supply 7 is a battery pack 24 or an AC adapter, not shown, and 3.3 V DC is supplied to the power supply circuit 106 via the connector 102, for example. Further, the power supply 7 supplies power to the entirety of the information processing apparatus 1.

The host apparatus 8 is a main circuit board, in this embodiment, and the south bridge 113 mounted on the main circuit board is connected to the control unit 103. Data transmission is made between the south bridge 113 and the control unit 103 based on the standard of a serial ATA, for example.

The external apparatus 9 is an information processing apparatus differing from the information processing apparatus 1. With respect to the SSD 10 detached from the information processing apparatus 1, the external apparatus 9 is connected to the control unit 103 based on standard of an RS-232c, for example, and has a function of reading data stored in the NAND memories 104A-104H.

The board on which the SSD 10 is mounted has, for example, the same outer shape and size as that of a hard disk drive (HDD) of a 1.8-inch type or a 2.5-inch type. In this embodiment, the outer shape and size is the same as that of the 1.8-inch type.

The control unit 103 controls operations of the NAND memories 104A-104H. More specifically, the control unit 103 controls reading/writing of data from/to the NAND memories 104A-104H in response to a request from the host apparatus 8. The data-transmission speed is 100 MB/sec in data reading and 40 MB/sec in data writing, for example.

Each of the NAND memories 104A-104H is, for example, a non-volatile semiconductor memory with 16 GB as a storage capacity, and is, for example, a multi level cell (MLC)-NAND memory (multi-value NAND memory) capable of 2-bit recording in one memory cell. The MLC-NAND memory generally has no advantage over rewritable times as compared with a single level cell (SLC)-NAND memory, but the storage capacity can be easily increased.

The NAND memories 104A-104H of the embodiment store applications capable of outputting the time information of the RTC 113A to the SSD 10 on the basis of a request from the SSD 10, and also counting a variety items of data such as an operating time and a temperature of the SSD 10 to display on the display unit 3 or print out.

The DRAM 105 is a buffer in which the data is temporarily stored at the time of data reading/writing from/to the NAND memories 104A-104H according to control of the control unit 103.

The connector 102 has a shape based on the standards such as a serial ATA. The control unit 103 and the power supply circuit 106 may be connected to the host apparatus 8 and the power supply 7, respectively, via different connectors.

The power supply circuit 106 converts 3.3 V DC supplied from the power supply 7 to 1.8 V, 1.2 V DC, for example, and supplies the three kinds of voltages to each component according to the drive voltage of each component of the SSD 10.

(Storage Capacity of SSD)

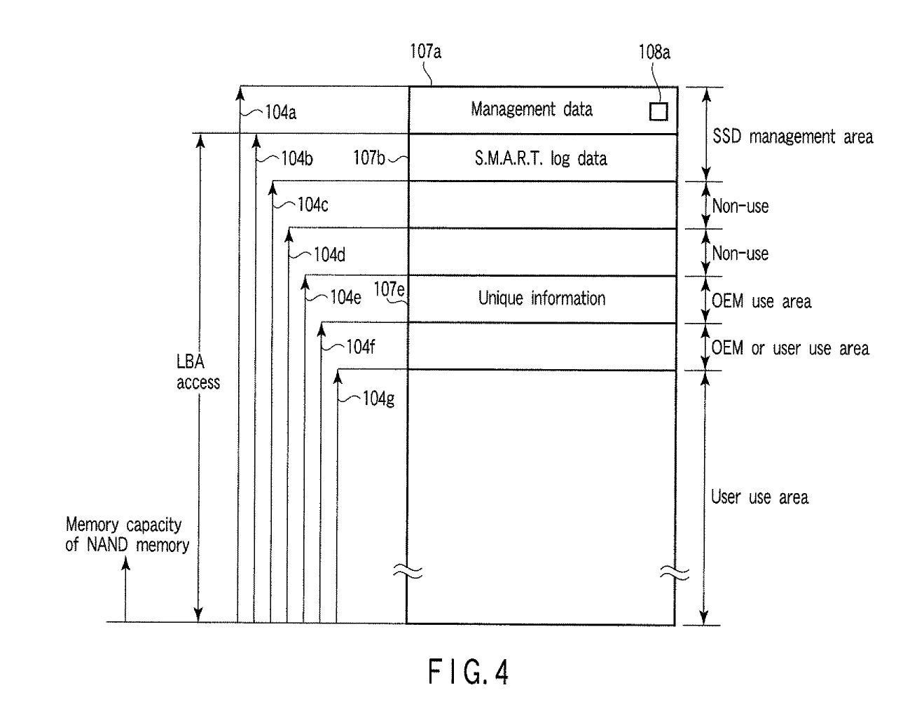

FIG. 4 schematically shows storage capacities and storage areas of the SSD 10 according to the embodiment of the invention. The storage capacity of the SSD 10 is formed of storage capacities 104a-104g as shown in FIG. 4.

The storage capacity 104a is a NAND Capacity, i.e., the maximum storage capacity using the storage areas of all the NAND memories 104A-104H. For instance, when the storage capacity of each of the NAND memories 104A-104H is 16 GB, the storage capacity 104a is 128 GB. The storage capacity 104a is given by NAND configuration information of a manufacturing information writing command of a universal asynchronous receiver transmitter (UART).

The storage capacity 104b is a Max Logical Capacity, and is the maximum storage capacity accessible by logical block addressing (LBA).

The storage capacity 104c is a self-monitoring analysis and reporting technology (S.M.A.R.T.) log area start LBA, and is provided for dividing the storage capacity 104b and the storage capacity 104d which will be described later. The details will be described later.

The storage capacity 104d is a Vendor Native Capacity, and is the maximum storage capacity given as a user use area. The storage capacity 104d is given by an initial Identify Device data of an ATM specific command. The storage capacity 104d is determined by the vendor at a design stage of the SSD 10 based on the International Disk Drive Equipment and Memory Association (IDEMA) standard, and is expressed by the following Equation 1:

LBA=97,696,368+(1,953,504×((Capacity in GB)−50)) Equation 1

The storage capacity 104e is an original equipment manufacturer (OEM) Native Capacity, and is the storage capacity determined at the time of manufacturing in response to a request from the OEM. The storage capacity 104e is given by writing unique information of an ATM specific command. The storage capacity 104e is a value returned by a Device Configuration Identify command when a Device Configuration Overlay Feature Set is supported.

The storage capacity 104f is a Native Capacity, and its initial value is the same value as the storage capacity 104e. The storage capacity 104f is a value which can be changed by a Device Configuration Set command when a Feature Set is supported. Further, the storage capacity 104f is a value returned by a Read Native Max Address (EXT) command.

The storage capacity 104g is a Current Capacity, and is the storage capacity during use by the user. The initial value of the storage capacity 104g is the same value as the storage capacity 104f. The storage capacity 104g can be changed by a Set Max Address command. The value is returned by Word 61:60 and Word 103:100 of an Identify Device command.

The storage areas of the SSD 10 exist between adjacent ones of the storage capacities 104a-104g.

In a storage area between the storage capacities 104a and 104b, a management data (management information) 107a for operating the SSD 10 and a logical/physical table 108a for converting a logical address of data converted from the LBA into physical addresses corresponding to a sector which is a storage unit of the NAND memories 104A-104H are stored. The management data 107a and the logical/physical table 108a are data which cannot be accessed by using the LBA as a key, and is recorded, by using a fixed access path, in a fixed area in the NAND memories 104A-104H.

In a storage area between the storage capacities 104b and 104c, S.M.A.R.T. log data 107b which is statistical information of the foregoing temperature information, for example, is stored. The S.M.A.R.T. log data 107b is accessed by using the LBA as a key in being recorded an inside of firmware, and is not be accessed by an ordinary Read command or a Write command from the host apparatus 8.

In a storage area between the storage capacities 104c and 104d, a nonuse storage area having a storage capacity of 2 MB is set, for example. This is in order to handle the S.M.A.R.T. log data 107b and the data recorded in the storage capacity 104d or latter independently by providing a free storage area having a storage capacity of more than 1 MB, since a minimum storage unit of actual data is naturally 1 sector while a minimum storage unit of the LBA is 8 sectors and is the storage unit corresponding to 4 KB (a large storage unit is 1 MB).

A storage area between the storage capacities 104d and 104e is unused and both the storage capacities have the same value except in special cases.

A storage area between the storage capacities 104e and 104f is a storage area used by the OEM, and the unique information 107e determined by a request from the OEM is written as described above.

A storage area between the storage capacities 104f and 104g is a storage area used by the OEM or the user, and data is written therein by setting by the OEM or user.

A storage area of the storage capacity 104g is a storage area used by the user, and data is written therein by setting by the user.

A storage capacities 104a-104g satisfy the relationship expressed by the following Equation 2:

Storage capacity 104a>storage capacity 104b>storage capacity 104c>storage capacity 104d>=storage capacity 104e>=storage capacity 104f>=storage capacity 104g Equation 2

At the time of shipping from a vender, the storage capacities 104d-104g are the same values.

(Configuration of NANAD Memory)

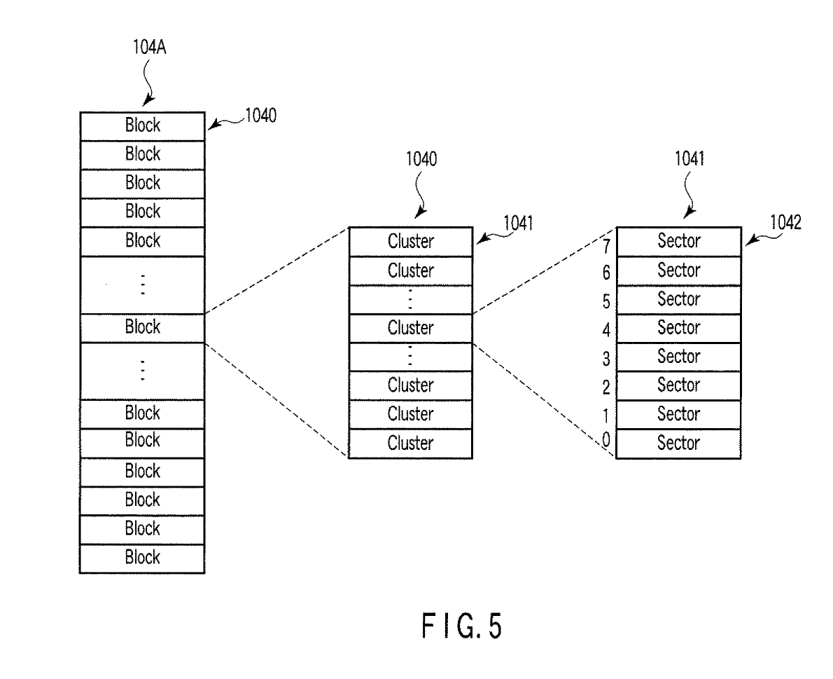

FIG. 5 shows a schematic configuration of a NAND memory according to the embodiment of the invention. Since the NAND memories 104A-104H each have the same function and configuration, an explanation will be made only about the NAND memory 104A. As one example, it is assumed that numbers 0-7 at the left of a sector 1042 indicate sector numbers.

The NAND memory 104A is composed of a plurality of blocks 1040. Each of the blocks 1040 is composed of 1024 clusters 1041, and each of the cluster 1041 is further composed of 8 sectors 1042.

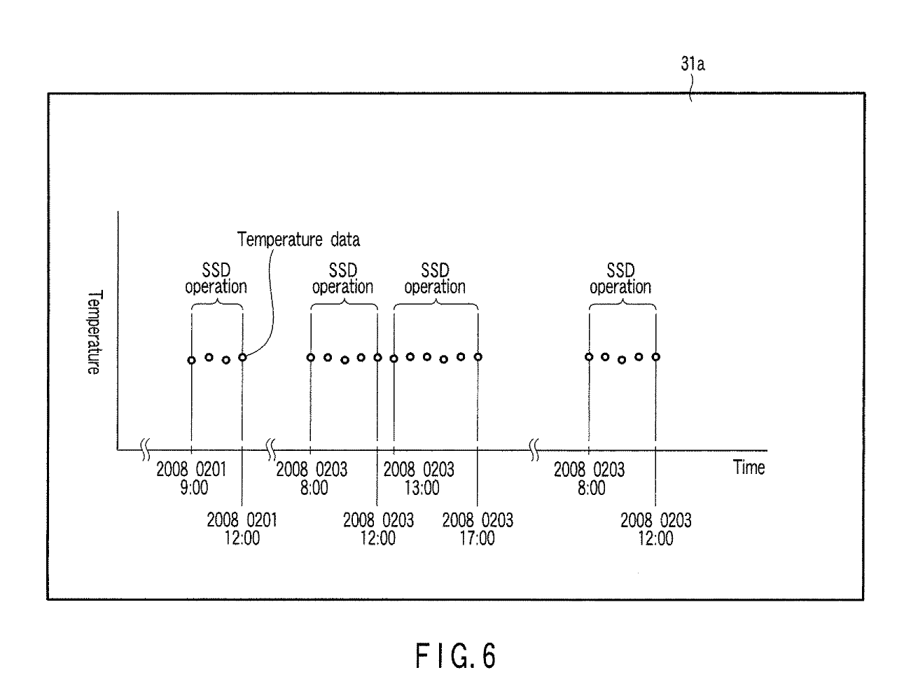

FIG. 6 shows a view illustrating an operation time period of the SSD 10 of the embodiment of the invention. In the SSD 10 of the embodiment, the counter 103A installed in the control unit 103 counts internal reference pulses in operation to store the count value in the management data 107a shown in FIG. 4.

FIG. 6 shows operation situations of the SSD 10 through the foregoing application executed by the information processing apparatus 1 and the change in temperature as a graph, and the graph is displayed as a screen on the display 31a disposed at the display unit 3 of the information processing apparatus 1. As regards the operation situations of the SSD 10, the activation timing of the SSD 10 and the stop timing of the SSD 10 are processed by reading, via the south bridge 113, the data with time information based on the externally acquired real time added thereto. As regards the change in temperature of the SSD 10, the temperature sensor 101 disposed at the SSD 10 indicates the temperatures of the NAND memories 104A-104H together with temperature data obtained at every one hour.

When the information processing apparatus 1 is turned on and after activating the OS, the real time acquisition module 103B acquires the time information of the RTC 113A of the information processing apparatus 1 on the basis of the application to be read from the NAND memories 104A-104H of the SSD 10 on the basis of the operations of the touch pad 20 and the keyboard 23a to be executed, and may grasp when the SSD 10 has been activated, when the SSD 10 has stopped operating, and how long has it operated for. The acquisition module 103B may also grasp the time from the last stop of operation to the time of the next activation of the SSD 10. While FIG. 6 has illustrated the graph in a coordinate system wherein the ordinate axis is temperature and the abscissa axis is time, such a display may display a screen on the display device 31 of the information processing apparatus 1 by processing through the application.

The real time acquisition module 103B adds the time information to the count value counted by the counter 103A, computes the times of the activation and the stop of the operation of the SSD 10, and stores the times in the NAND memories 104A-104H. Thereby, the control unit 103 becomes able to grasp the time period from the operation stop to the next activation of the SSD 10.

The electric charges accumulated in the NAND memories 104A-104H are lost due to a junction leakage and a leakage current of transistors with the elapse of time. To complement a storage property (a retention property) of the electric charge, the control unit 103 sets a threshold for the time period from the operation stop to the next activation of the SSD 10, and if the time period from the last operation stop has exceeded the threshold when the SSD 10 has been activated next, controls, for example, to increase the frequency of checks of the data storage situation so as to prevent the data stored in the NAND memories 104A-104H from being deleted.

(Operation)

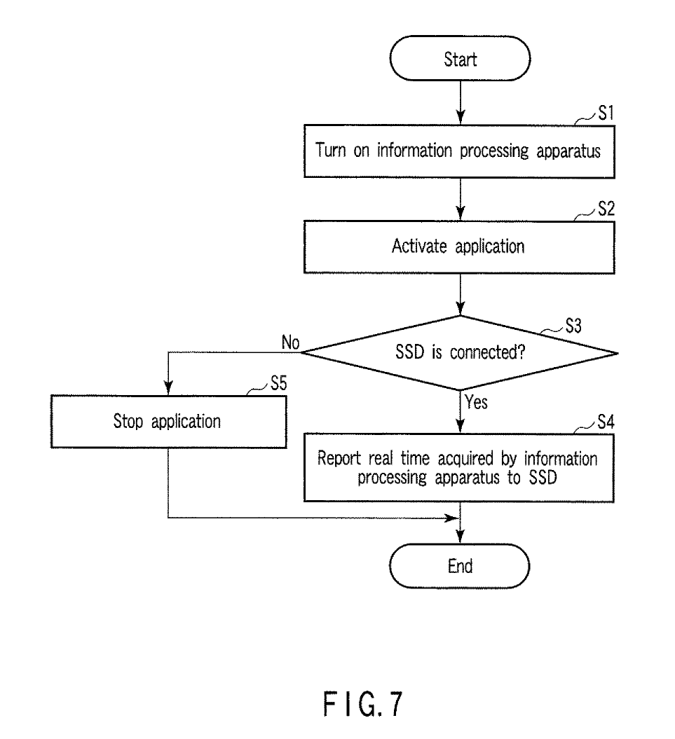

FIG. 7 is an exemplary flowchart showing operations of the information processing apparatus 1 of the embodiment of the invention.

The operations of the information processing apparatus 1 will be described hereinafter.

Firstly, when the user operates the power switch 25 of the information processing apparatus 1 to turn on the power supply (S1), the south bridge 113 gives an instruction to activate the SSD 10 then the OS stored in the NAND memories 104A-104H are read in the information processing apparatus 1 to activate the OS.

After activating the OS, the CPU 115 of the information processing apparatus 1 reads an application which has been stored in the NAND memories 104A-104H, set so as to be activated with powering on the information processing apparatus 1, and outputs the time information of the activation time to the SSD 10 via the south bridge 113. Thereby, the application is activated (S2).

Here, the CPU 115 of the information processing apparatus 1 confirms devices which have been connected in the process of the activation of the OS stored in the NAND 104A-104H. If the SSD 10 has been connected (Yes in S3), and when the notification of the time information is required from the SSD 10, the CPU 115 outputs the time information at the activation time from the RTC 113A to the SSD 10 via the south bridge 113 (S4). If the SSD 10 has not been detected (No in S3), the CPU 115 stops the application (S5).

After displaying the activation screen of the OS on the display 31a, the display device 31 of the information processing apparatus 1 displays an icon indicating the activation of the foregoing application, for example, at the lower right of the screen of the display 31a. The user may select to display or not to display the screen display showing the activation of the application.

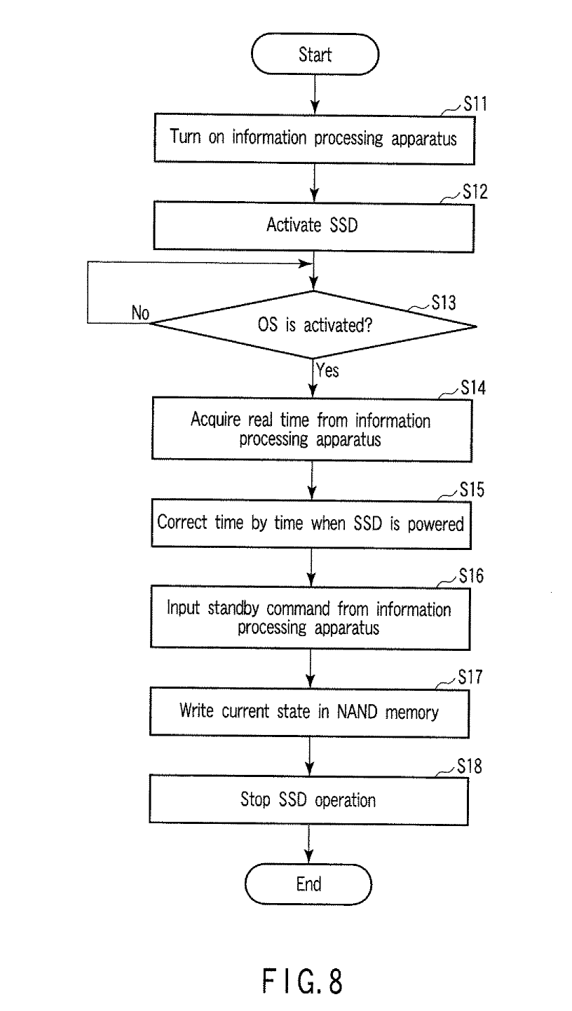

FIG. 8 is an exemplary flowchart showing operations of the SSD of the embodiment of the invention. The following will describe the operations of the SSD 10 while referring to the drawings FIG. 1, FIG. 2, FIG. 3, FIG. 4, FIG. 5 and FIG. 6.

When the power is turned on the basis of the operation of the power switch 25 of the information processing apparatus 1 (S11), the south bridge 113 issues an instruction of the activation to the SSD 10 then the SSD 10 is activated (S12), the temperature sensor 101 of the SSD 10, the control unit 103, the NAND memories 104A-104H, the DRAM 105 are powered on. Next, a boot loader included in the management data 107a of the SSD 10 reads firmware (FW) stored in the NAND memories 104A-104H in the DRAM 105 to load the firmware. The firmware loaded in the DRAM 105 further reads a storage state stored in the NAND memories 104A-104H.

If the OS stored in the NAND memories 104A-104H is activated to enable operating each unit of the information processing apparatus 1 (Yes in 513), the SSD 10 requires the real time acquisition module 103B to the CPU 115 of the information processing apparatus 1 to report the real time acquisition. The acquisition module 103B of the control unit 103 acquires the time information output from the RTC 113A on the side of the information processing apparatus 1 through the south bridge 113 in response to the report request for the time information (S14).

Here, the acquisition module 103B corrects the activation time on the basis of the time information acquired from the application on the side of the information processing apparatus 1. This is because the SSD 10 has been turned on before the acquisition module 103B has acquired the time information, thus there is a deviation between the time when the power is turned on and the time when the SSD actually becomes operable.

The real time acquisition module 103B refers to the count value of the counter 103A which has been operating after powering on, obtains the difference between the count value at the time when the SSD has actually become operable and the count value when the power has been turned on, calculates the time when the power of the SSD 10 is turned on the basis of the difference, and the calculated time is added. In this way, correcting the time enables obtaining the time when the power of the SSD 10 is turned on (S15).

The time when the power of the SSD 10 is turned off may be obtained on the basis of the result in subtraction of the count value when the power is turned on from the cont value when the power is turned off.

For instance, when inputting a standby command via the south bridge 113 of the information processing apparatus 1 in normal operation (S16), the control unit 13 of the SSD 10 writes to store the current storage state into the NAND memories 104A-104H (S17) to turn off the power. Thereby, the SSD 10 stops operating (S18).

In this way, grasping the time of the activation of the SSD 10 and the time of the stop of the operation of the SSD 10, based on the time information acquired from the RTC 113A of the information processing apparatus 1, enables precisely and easily obtain the time from the last operation stop to the next activation by means of the control unit 103 without having to provide an RTC for the SSD 10. Thereby, if the time period from the last operation stop to the next activation has exceeded the preset threshold, it becomes able, if necessary, to perform processing such as an increase in frequency of consistency checks of the data stored in the NAND memories 104A-104H.

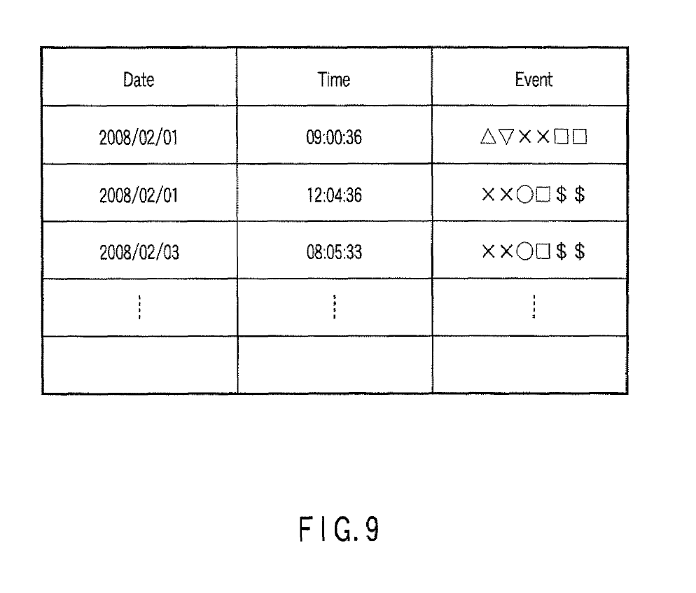

While the aforementioned embodiment has been described a method for grasping the time of the activation of the SSD 10 and the time of the stop of the operations of the SSD 10 on the basis of the time information output from the RTC 113A of the information processing apparatus 1, it is also able, for example, to grasp the activation time and the stop time from the time information to be added to the event logs, as shown in FIG. 9. In this case, upon the occurrence of an event at the SSD 10, adding the data and the time to an event item and store them in the NAND memories 104A-104H, and reading them into the information processing apparatus 1 through the south bridge on the basis of the foregoing application enables them to be displayed on the display 31a of the display unit 3.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an information processing apparatus main body; and
a non-volatile semiconductor memory drive which is accommodated in the information processing apparatus main body,
the information processing apparatus main body including:
a clock module configured to count time information; and
a main control module configured to output the time information to be counted by the clock module to the non-volatile semiconductor memory drive upon powering on,
the non-volatile semiconductor memory drive including:
a counter; and
a memory control module configured to calculate and manage times upon powering on and shutting down power and an elapsed time from the time upon last shutting down power to time upon present powering on based on a value of the counter and the time information input from the information processing apparatus main body.

2. The information processing apparatus of claim 1, wherein the memory control module of the non-volatile semiconductor memory drive executes to control a check of a storage state of a non-volatile semiconductor memory based on the calculated elapsed time.

3. The information processing apparatus of claim 1, wherein the memory control module of the non-volatile semiconductor memory drive acquires the time of the powering on by correcting the time information input from the information processing apparatus main body so as to subtract a difference value between a value of the counter upon inputting the time information from the information processing apparatus main body and a value of the counter upon powering on.

4. An information processing apparatus comprising:
an information processing apparatus main body: and
a non-volatile semiconductor memory drive which is housed in the information processing apparatus main body,
the information processing apparatus main body including:
a clock module configured to count time information; and
a main control module configured to output the time information to be counted by the clock module to the non-volatile semiconductor memory drive upon powering on; and
the non-volatile semiconductor memory drive including:
a counter; and
a memory control module configured to record actual times in an event log, the actual times being calculated from a value of the counter and the time information input from the information processing apparatus main body.

5. A non-volatile semiconductor memory drive which is accommodated in an information processing apparatus main body comprising:
a counter;
a time information input module configured to input time information from the information processing apparatus main body; and
a memory control module configured to calculate and manage times upon powering on and shutting down power and an elapsed time from the time upon last shutting down power to time upon present powering on based on a value of the counter and the time information input by the time information input module.

6. The non-volatile semiconductor memory drive of claim 5, wherein the memory control module executes to control a check of a storage state of a non-volatile semiconductor memory based on the calculated elapsed time.

7. The non-volatile semiconductor memory drive of claim 5, wherein the memory control module acquires the time of the powering on by correcting the time information input from the information processing apparatus main body so as to subtract a difference value between a value of the counter upon inputting the time information from the information processing apparatus main body and a value of the counter upon powering on.
